(19) United States
(12) Patent Application Publication
(10) Pub. No.: US 2012/0040157 A1
(43) Pub. Date: Feb. 16, 2012

(54) SUPERHARD ELEMENT, A TOOL COMPRISING SAME AND METHODS FOR MAKING SUCH SUPERHARD ELEMENT

(76) Inventors: Igor Yuri Konyashin, Burghaun (DE); Sebastian Ralf Hlawatschek, Burghaun (DE); Bernd Heinrich Ries, Burghaun (DE); Frank Friedrich Lachmann, Burghaun (DE)

(21) Appl. No.: 13/203,475

(22) PCT Filed: Mar. 1, 2010
(86) PCT No.: PCT/IB2010/050872

§ 371 Date: Nov. 2, 2011

(30) Foreign Application Priority Data
Feb. 27, 2009 (GB) 0903322.6

(51) Int. Cl. B32B 7/02; B22F 7/00; B22F 3/11; B32B 15/04; B32B 3/00

(52) U.S. Cl. 428/212; 428/457; 428/334; 419/2; 419/9

(57) ABSTRACT

The invention relates to a superhard element (10) comprising a polycrystalline superhard structure (20) joined at an interface to a hard-metal body (30) comprising metal carbide grains bonded together by a metal binder, the polycrystalline superhard structure comprising a superhard material; the hard-metal body comprising a surface region (32) proximate the interface and a core region (36) remote from the interface, the surface and the core regions being contiguous, the mean binder fraction in the core region being less than that in the surface region and to a method of making a hard-metal body for such an element.

### FIELD

This invention relates to superhard elements, tools comprising same and a method for making same. The invention relates more particularly, but not exclusively, to superhard elements and tools comprising same for use in boring into the earth, degrading or drilling into rock, pavement, asphalt and other hard or abrasive materials. Further, the invention relates more specifically to polycrystalline diamond elements comprising polycrystalline diamond structures joined to cemented carbide substrates, tools comprising same and to a method for making same.

### BACKGROUND

As used herein, a hard-metal is a material comprising grains of metal carbide such as tungsten carbide (WC) or titanium carbide (TiC), dispersed within a binder phase comprising a metal such as cobalt (Co), nickel (Ni) or metal alloy. The binder phase may be said to cement the grains together as a sintered element, typically having negligible porosity. The most common hard-metal is Co-cemented WC.

Superhard materials such as diamond are used in a wide variety of forms to machine, bore and degrade hard or abrasive work-piece materials. These materials may be provided as single crystals or polycrystalline structures comprising a directly sintered mass of grains of diamond forming a skeletal structure, which may define a network of interstices between the diamond grains. The interstices may contain a filler material, which may comprise a sintering aid for the diamond and possibly also a hard phase such as an inter-metallic or ceramic material. The filler material may be fully or partially removed in order to alter certain properties of the diamond structure material.

Polycrystalline diamond (PCD) is a superhard material comprising a coherent sintered-together mass of diamond grains. The diamond content may typically be at least about 80 volume percent and form a skeletal mass defining a network of interstices. The interstices may contain filler material comprising cobalt. Many PCD materials exploited commercially have mean diamond grain size of at least about 1 micron. PCD comprising diamond grains having mean size in the range from about 0.1 micron to about 1.0 micron are also known, and PCD comprising nano-grain size diamond grains having mean size in the range from about 5 nm to about 100 nm have been disclosed.

Hard-metal bodies may be used as substrates for polycrystalline superhard materials, particularly for polycrystalline diamond structures. Superhard elements comprising polycrystalline superhard structures joined to hard-metal substrates may be used in attack tools and cutters, such as picks, percussive drill bits and rotary drill bits, as may be used in the mining, tunnelling, element and oil and gas industries to process or degrade pavements or rock formations, or to bore into the earth. The hard-metal bodies may be joined to a tool carrier by means of liquid brazing solders.

PCT patent publication number WO 02/14568 discloses a cutting insert comprising tungsten carbide and a binder alloy, the substrate having a bulk region and a surface zone of binder alloy enrichment that has a maximum binder alloy content greater than the binder alloy content in the bulk region of the substrate. The cutting insert may comprise a hard coating on the substrate.

PCT patent publication number WO 02/42515 discloses a method for making cemented carbide inserts. The inserts are first heat-treated in a decarburizing atmosphere to form an eta-phase containing surface zone, then heat-treated in neutral gas atmosphere or in vacuum to retransform the eta phase in the surface zone completely to WC+Co.

United States patent application publication number 2008/0240879 discloses a block for a cutter for a drilling bit the block having been treated by imbibation.

A diamond table of PDC (polycrystalline diamond compact) or TSP (thermally stable polycrystalline diamond) type can be applied to the block directly by a high pressure-high temperature process to the block previously treated by imbibition. It is also possible for the diamond table to be applied to a different homogeneous cermet supporting block, which is subsequently applied by imbibition to the first block treated by imbibition.

In an embodiment, a cutter for a drilling tool for cutting and/or grinding rocks, such as a PDC drill bit, TSP drill bit, a boring bit, a mine pick, a tricone bit, an impregnated tool, comprises a block constituted by metal carbide(s) dispersed in a binder phase especially of the WC−Co type, optionally with added diamonds, which comprises a continuous composition gradient in the binder phase, of a form defined by the function of the tool, so as to obtain a tough core rich in binder phase and a surface poor in binder phase, having a high degree of hardness.

The cutter can further be surmounted by a diamond table of PDC or TSP type on one face of the block.

### SUMMARY

The purpose of the invention is to provide a polycrystalline superhard element having enhanced resistance to fracture

As used herein, “superhard” means having a Vickers hardness of at least about 25 GPa.

As used herein, “metal” means a metal in elemental form or an alloy having typical metallic properties, such as electrical conductivity.

As used herein, “binder fraction” is the ratio of the mean weight of binder per unit volume to the mean weight of hard-metal per unit volume within a body or portion thereof.

As used herein, “substantially devoid” of means that if an amount of a certain material, substance or phase is detectable within a hard-metal body, the amount is so small that it has no material effect on the performance of the hard-metal body, at elevated temperatures, for example 700 to 800 degrees Celcius.

A first aspect of the invention provides a superhard element comprising a polycrystalline superhard structure joined at an interface to a hard-metal body comprising metal carbide grains and a metal binder; the polycrystalline superhard structure comprising a superhard material; the hard-metal body comprising a surface region proximate the interface and a core region remote from the interface, the surface and the core regions being contiguous, the mean binder fraction in the core region being less than that in the surface region.

As used herein, “based on” means “comprises”.

As used herein, “a sintering aid” is a material that is capable of promoting the sintering-together of grains of a superhard material. Known sintering aid materials for diamond include iron, nickel, cobalt, manganese and certain alloys involving these elements. These sintering aid materials may also be referred to as a solvent/catalyst material for diamond.

In one embodiment, the metal binder comprises a sintering aid for the superhard material. In one embodiment, the metal binder is based on cobalt or cobalt and nickel. In one embodiment, the metal carbide is tungsten carbide.

As used herein, “polycrystalline diamond” (PCD) is a material comprising a mass of substantially inter-grown diamond grains, forming a skeletal structure defining interstices between the diamond grains, the material comprising at least 80 volume percent of diamond.

As used herein, “polycrystalline cubic boron nitride” (PCBN) is a material comprising grains of cubic boron nitride (cBN) dispersed in a matrix, the material comprising at least 50 volume percent of cBN.

In one embodiment, the polycrystalline superhard structure comprises polycrystalline diamond (PCD) and the metal binder comprises a solvent/catalyst material for diamond. In another embodiment, the polycrystalline superhard structure comprises polycrystalline cubic boron nitride (PCBN).

In one embodiment, the mean carbon concentration within the binder is less in the surface region than in the core region.

An eta-phase composition means a carbide compound having the general formula Mₓ M′_{y} C_{z}, where M is at least one element selected from the group consisting of W, Mo, Ti, Cr, V, Ta, Hf, Zr, and Nb; M′ is at least one element selected from the group consisting of Fe, Co, Ni, and C is carbon. Where M is tungsten (W) and M′ is cobalt (Co), as is the most typical combination, then eta-phase is understood herein to mean CO₃W₃C (eta-1) or CO₆W₆C (eta-2), as well as fractional sub- and super-stoichiometric variations thereof.

In one embodiment, both the surface region and the core region are substantially devoid of eta-phase. In one embodiment, the hard-metal body is substantially devoid of eta-phase and in one embodiment the hard-metal body is substantially devoid of eta-phase and free carbon.

In some embodiments, the surface region is substantially devoid of grain growth inhibitors or their precursors. In some embodiments, the surface region is substantially devoid of chromium or vanadium or their carbides, or any combination of these.

Embodiments of the invention have the advantage that grain growth inhibitors are not present in the surface region, which will avoid the deleterious effect of grain growth inhibitors on certain properties of the hard-metal material of the body, especially the fracture toughness.

As used herein, the magnetic moment a of a material is in units of micro-Tesla times cubic metre per kilogram of the material. The magnetic saturation of the material is obtained from the magnetic moment by multiplying it by 4π.

In some embodiments where the metal binder is based on cobalt or cobalt and nickel, the mean magnetic moment, σ, in units of micro-Tesla times cubic metre per kilogram, of the hard-metal is in the range from 0.131Y to 0.161Y within the core region, and in the range from 0.110X to 0.147X within the surface region, where X and Y are the cobalt fractions, in weight %, within the surface and core regions, respectively. In one embodiment, the mean magnetic moment in the core region is at least 0.140Y and the mean magnetic moment in the surface region is less than 0.140X.

In one embodiment, the mean magnetic coercivity, H_{c}, of the hard-metal within the surface region is within 5% of that within the core region, or higher than that within the core region by a factor, the factor being in the range from 1.05 to 1.80. In one embodiment, the mean magnetic coercivity, H_{c}, of the hard-metal within the surface region is within 5% of that within the core region.

In some embodiments, the mean hardness of the hard-metal within the core region is at least 2% or at least 10% greater than the mean hardness of the hard-metal within the surface region. In one embodiment, the mean hardness of the hard-metal within the core region is at most 50% greater than the mean hardness of the hard-metal within the surface region.

In one embodiment, the surface region has the form of a stratum or layer integrally formed with (proximate) the core region. In some embodiments, the surface region has thickness of at least about 0.2 mm, at least about 0.5 mm or even at least about 1 mm. In some embodiments, the surface region has thickness of at most about 5 mm or even at most about 10 mm. In one embodiment, the surface region has thickness within the range from 0.2 mm to 10 mm. In some embodiments and subject to the thickness of the surface region, the core region has a maximum depth from the surface within the range from about 0.5 mm to about 15 mm, in the range from about 1 mm to about 10 mm, or in the range from about 2 mm to about 5 mm.

In one embodiment, the mean binder fraction within the core region is lower than that within the surface region by a factor, the factor being in the range from about 0.05 to about 0.90.

In one embodiment, the mean grain size of the metal carbide grains within the surface region is within 5% of that within the core region, or higher than that within the core region by a factor, the factor being in the range from 1.05 to 1.50.

In one embodiment, the metal binder fraction within the surface region decreases monotonically with depth from the surface over any range of depths within the surface region and the hardness within the surface region increases monotonically with depth from the surface over any range of depths within the surface region. The term “monotonically” means that the curve is smooth.

In one embodiment, the mean fracture toughness of the hard-metal within the core region is in the range from 5% to 50% higher than that in the surface region.

In one embodiment, the hard-metal comprises a concentration of Cr, V, Ta, Ti, Nb, Zr, Hf or Mo in the form of either metal carbides or solution in the binder, and in one embodiment the concentration is 2 weight % or less, 0.5 weight %, or less or even 0.3 weight % or less. In one embodiment, the concentration within the binder is substantially uniformly distributed throughout the surface and core regions.

In one embodiment, the superhard element comprises a polycrystalline diamond compact.

An aspect of the invention provides a tool comprising an embodiment of a superhard element according the invention.

Embodiments of the invention have the advantage that the hard-metal body comprises a relatively stiff core region having relatively low cobalt content and a relatively less stiff surface region having relatively more cobalt. This results in improved resistance to fracture of the superhard structure in use, thereby extending the working life of a tool comprising an embodiment of a superhard element according to the invention.

Embodiments of the invention are readily brazed on onto a tool carrier, such as a drill bit, since the excess cobalt in the surface region may promote the wetting of the surface of the body by certain brazes and braze solders.

As used herein, carbon content means the total carbon content per unit volume within a hard-metal body or portion thereof, including free and reacted carbon and carbon included in metal carbide grains. “High carbon content” is understood to mean a total carbon content that is i) sufficiently low that substantially no free carbon forms and ii) sufficiently high that the magnetic moment, σ, in units of micro-Tesla times cubic metre per kilogram, of the hard-metal is in the range from 0.131Y to 0.161Y where Y is the cobalt fraction, in weight %. The range of carbon contents corresponding to a low carbon content depends on various factors related to the nature and composition of the hard-metal, as would be appreciated by the person skilled in the art.

A green body is a term known in the art and refers to an article intended to be sintered, but which has not yet been sintered. It is generally self-supporting and has the general form of the intended finished article.

According to a second aspect of the present invention method for making a hard-metal body for a superhard element according to a first aspect of the invention is provided, the method including providing an unsintered green body comprising grains of metal carbide dispersed within a metal binder, and an initial high carbon content within the green body; the green body comprising a surface region proximate a surface and a core region remote from the surface and contiguous with the surface region; heat treating the green body at a temperature less than 1,280 degrees centigrade for a period of time in a vacuum or inert atmosphere, the temperature being sufficiently low to avoid substantial melting of the metal binder and the temperature and time being sufficient to maintain open porosity within the surface region of green body; introducing a gaseous decarburising agent into the pores to form a decarburised surface region within the green body and maintaining the initial high carbon content within at least a portion of the core region; and liquid-phase sintering the green body.

An embodiment of this method includes
(1) providing an unsintered porous green body comprising grains of metal carbide dispersed within a metal binder, the binder having a high total carbon content;
(2) pre-sintering the green body at a certain temperature below 1,280 degrees centigrade in a vacuum or protective (inert) atmosphere to obtain a desired open porosity in the surface region and a substantially close porosity in the core;
(3) selectively de-carburising the pre-sintered green body in a de-carburising gas atmosphere at a temperature below 1,280 degrees centigrade and time to de-carburise only the surface layer and substantially maintain the high carbon content in the core, and
(4) final sintering of the pre-sintered and carburised green body at a temperature above 1,300 degrees centigrade in a vacuum or protective atmosphere to obtain the full density.

Embodiments of the method have the advantage that the carbon may permeate the hard-metal from a substantial depth in a regulated way owing to the controlled open porosity, and consequently the avoidance of eta-phase in the core as well as the avoidance of free carbon in the surface region.

Embodiments of the method have the advantage that the cobalt content of the surface and core regions are controlled by means of carbon levels and by engineering the WC mean grain size in the surface and core regions. This may avoid the need to introduce locally grain a growth inhibitor, which may be technically difficult and which would tend to reduce the fracture toughness of the hard-metal body.

A third aspect of the present invention provides a method for making a polycrystalline diamond (PCD) element according to the invention comprising a PCD structure joined to a hard-metal body, the method including providing a hard-metal body comprising tungsten carbide grains and a binder material comprising a solvent/catalyst material for diamond, selected from cobalt, nickel, iron, manganese and alloys including any of these, the hard-metal body comprising a surface region proximate a surface and a core region remote from the surface, the surface and the core regions being contiguous, the binder fraction in the core region being less than that in the surface region; contacting an aggregate mass of diamond grains with the surface of the hard-metal body to form a pre-sinter assembly; and subjecting the pre-sinter assembly to a pressure and temperature at which diamond is thermodynamically stable to sinter the diamond grains and form a PCD structure integrally bonded to the hard-metal body.

An embodiment of the method includes removing at least part of the surface region of the hard-metal body. In one embodiment, sufficient of the surface region is removed to expose the core region.

Embodiments of the invention have the advantage of providing a well-sintered superhard structure joined to a hard-metal body having enhanced stiffness, at least part of the surface of the hard-metal body having enhanced resistance to wear.

Some embodiments of the invention have the advantage that sintering aid material for promoting the formation of the superhard structure may be drawn from surface region of the hard-metal body, which may be relatively richer in sintering aid than the core region, without requiring the content of sintering aid material to be high throughout the hard-metal body. This allows for excellent sintering of embodiments of superhard structures to be integrally formed onto stiff substrate bodies. For example, where the superhard material is diamond and the hard-metal body comprises cobalt-cemented tungsten carbide, a PCD structure may be formed and integrally bonded to the surface of the hard-metal body in a sintering step carried out at an ultra-high pressure and temperature of greater than about 5 GPa, the cobalt sintering aid for the diamond being drawn from the cobalt-rich surface region of the hard-metal body.

### DRAWING CAPTIONS

Non-limiting preferred embodiments will now be described with reference to the drawings, of which

FIG. 1 showns a schematic cross sectional view of an embodiment of a PCD element.

FIG. 2 showns a schematic cross sectional view of an embodiment of a PCD element.

FIG. 3A shows a schematic graph of the binder content of an embodiment of a graded hard-metal as a function of depth from a surface.

FIG. 3B shows a schematic graph of the hardness of an embodiment of a graded hard-metal as a function of depth from a surface.

FIG. 3C shows a schematic graph of the carbide grain size of an embodiment of a graded hard-metal as a function of depth from a surface.

FIG. 3D shows a schematic graph of the carbon content of an embodiment of a graded hard-metal as a function of depth from a surface.

FIG. 4A And FIG. 4B show micrographs of a surface region and core region, respectively, of an embodiment of a cemented carbide body, the magnification being 1000×.

The same reference numbers refer to the same features in all of the drawings.

### DETAILED DESCRIPTION OF EMBODIMENTS

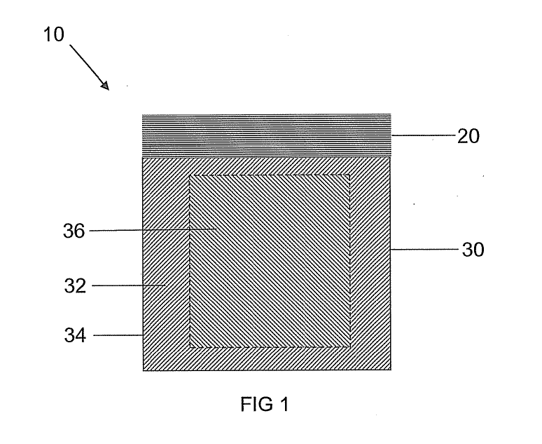

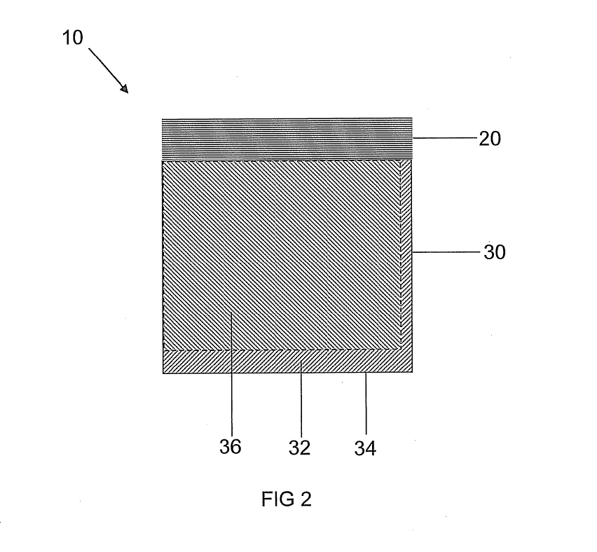

With reference to FIG. 1 and FIG. 2, embodiments 10 of superhard elements each comprise a polycrystalline superhard structure 12 joined at an interface 14 to a hard-metal body 16 comprising metal carbide grains (not shown) bonded together by a metal binder (not shown). The inherent function of the metal binder is to bond the grains, although the grains are not directly bonded together. The polycrystalline superhard structures 12 each comprise a superhard material. The hard-metal bodies 16 each comprise a surface region 18 proximate the interface 14 and a core region 19 remote from the interface 14, the surface and the core regions 18 and 19 being contiguous, the mean binder fraction in the core region 19 being less than that in the surface region 18.

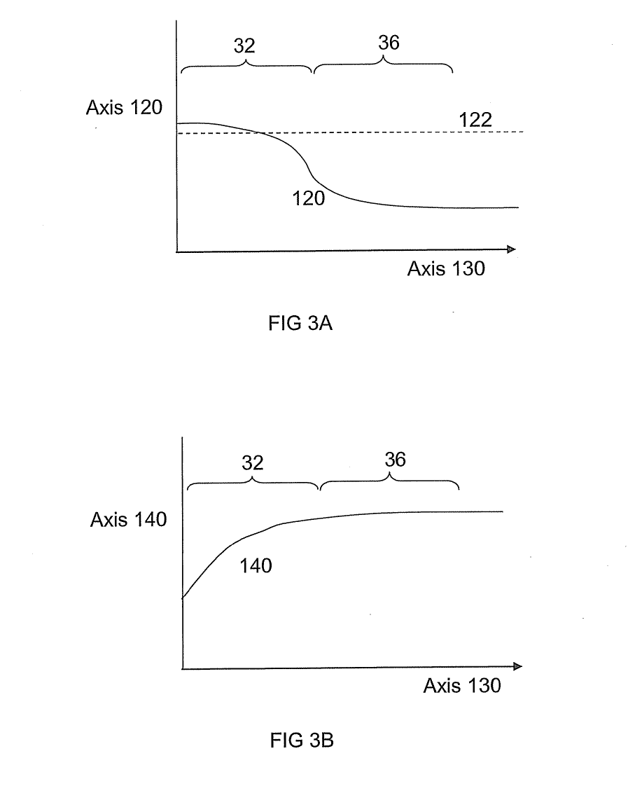

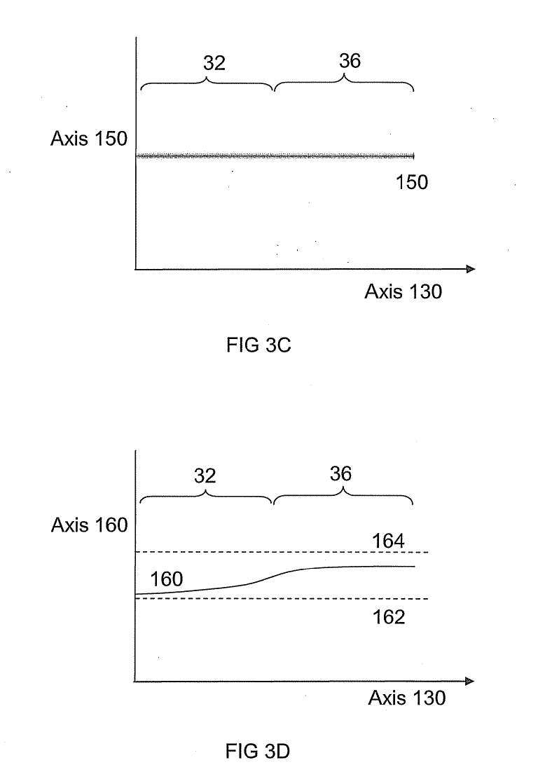

With reference to FIG. 3A, the cobalt binder fraction 120 of an embodiment of a hard-metal body is plotted on a schematic graph of cobalt content Axis 120 versus depth from a surface Axis 130 of the body. The cobalt binder fraction 120 decreases monotonically with depth from the surface Axis 130 of the hard-metal body having a mean cobalt binder fraction 122 through a surface region 18 and a core region 19.

With reference to FIG. 3B, the hardness 140 of an embodiment of a hard-metal body is plotted on a schematic graph of hardness Axis 140 versus depth from a surface Axis 130 of the body. The hardness 140 increases with increasing depth Axis 130 from the surface, the mean hardness being less within the surface region 18 than in the core region 19.

With reference to FIG. 3C, the mean tungsten carbide grain size 150 of an embodiment of a hard-metal body is plotted on a schematic graph of carbon content Axis 150 versus depth from a surface Axis 130 of the body. The mean tungsten carbide grain size 150 does not vary more than about plus or minus 5 percent between the surface region 18 and the core region 19.

With reference to FIG. 3D, the mean carbon content 160 of an embodiment of a hard-metal body is plotted on a schematic graph of hardness Axis 160 versus depth from a surface Axis 130 of the body. The mean carbon content 160 generally increases with increasing depth Axis 130 from the surface through the surface region 18 and the core region 19, the mean carbon content within the surface region 18 being less than the mean carbon content in the core region 19. The surface region 18 and the core region 19 are devoid of eta-phase and free carbon.

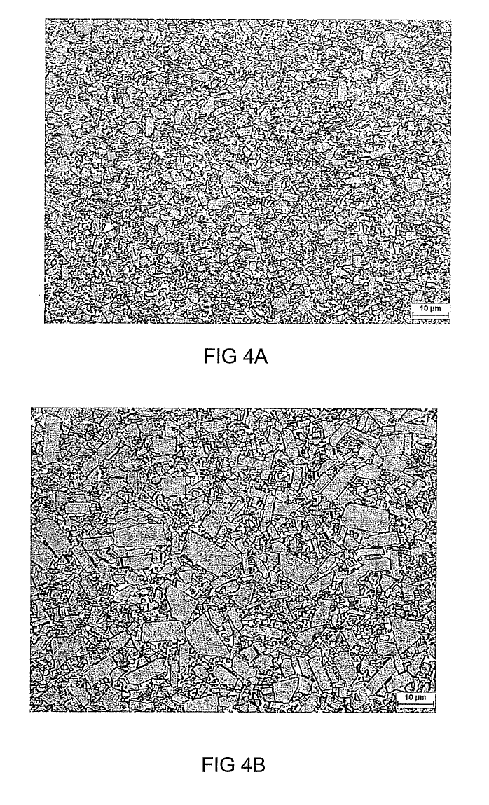

With reference to FIG. 4A and FIG. 4B, the mean size of WC grains within the surface region of an embodiment of a hard-metal body is substantially the same as that within the core region. The white portions of the micrographs represent the WC grains and the black portions representing cobalt binder.

The magnetic properties of the hard-metal can be related to important structural and compositional characteristics. The most common technique for measuring the carbon content in cemented carbides is indirectly, by measuring the concentration of tungsten dissolved in the binder to which it is indirectly proportional: the higher the content of carbon dissolved in the binder the lower the concentration of tungsten dissolved in the binder. The tungsten content within the binder can be determined from a measurement of the magnetic moment, σ or magnetic saturation, μ=4πσ, these values having an inverse relationship with the tungsten content (Roebuck (1996), “Magnetic moment (saturation) measurements on hard-metals”, Int J. Refractory Met., Vol. 14, pp. 419-424.).

The binder cobalt content within a hard-metal can be measured by various methods well known in the art, including indirect methods such as such as the magnetic properties of the hard-metal or more directly by means of EDX, but the most accurate method is based on chemical leaching of Co. The mean grain size of carbide grains, such as WC grains, can be determined by examination of SEM (scanning electron micrographs) or light microscopy images of metallurgically prepared cross-sections of a hard-metal body, applying the mean linear intercept technique, for example. Alternatively, the mean size of the WC grains can be measured indirectly by measuring the magnetic coercivity of the hard-metal, which indicates the mean free path of Co intermediate the grains, from which the WC grain size may be calculated using a simple formula well known in the art. This formula quantifies the inverse relationship between magnetic coercivity of a Co-cemented WC hard-metal and the Co mean free path, and consequently the mean WC grain size.

A preferred and novel method for making a graded hard-metal includes the following steps:
1. Prepare a green body comprising WC and Co powder by a suitable method, as is known in the art, ensuring that the carbon content is that desired for the core region of the finished body;
2. Subject the unsintered hard-metal green body to heat treatment in vacuum or inert or protective atmosphere for a period of time. It is important that the temperature is sufficiently low not to result in the cobalt binder melting, i.e. the temperature must be less than about 1,280 degrees centigrade. The combination of temperature and time is selected with the aim of maintaining a certain desired open porosity of the green body. Open porosity permits gas to permeate the body at a rate depending on the structure and amount of open porosity and the gas pressure, which should be in the range from 1 to 2 bars. A porous green body that has been subjected to the pre-sinter heat treatment has a certain desired open porosity. The heat treatment temperature versus time cycle that will result in the required porosity is best determined empirically, by trial and error, since it depends on various factors, such as the cobalt fraction and the desired depth of gas permeation, and consequently the thickness of the surface region;
3. Subject the porous, unsintered green body to a further heat treatment for a time period within an atmosphere comprising a decarburising agent, such as H₂ or CO₂, in order partially to decarburise it within a surface region. The gas pressure should be in the range from about 1 to 2 bars. It is again important that the temperature is sufficiently low not to result in the cobalt binder melting, i.e. the temperature must be less than about 1,280 degrees centigrade. The gas is allowed to permeate the body through the open pores, the depth of permeation being controlled by the time period. After this decarburisation stage, the porous body is partially depleted of carbon within the surface region, and concentration of carbon is lower within the surface region, increasing monotonically with depth into the body.
4. After the decarburisation stage, the article is sintered at a temperature above 1,320 degrees centigrade, as is known in the art. During this sintering stage, the cobalt liquefies and fills the pores, and carbon diffuses from the core region towards the surface region owing to the carbon gradient. This diffusion is associated with a well-known phenomenon known as “cobalt drift”, in which cobalt tends to migrate in the direction of carbon movement, from a region of high carbon concentration to one of lower carbon concentration, and so the cobalt as well as carbon moves from the core region towards to surface. The temperature and time combination used for liquid phase sintering is chosen to achieve a certain desired rate of dissolution and re-precipitation of fine WC grains in the surface and core regions, as is known in the art.

An embodiment of a polycrystalline diamond (PCD) element is formed by sintering a layer of diamond grains in contact with a cobalt-cemented tungsten carbide hard-metal substrate according to the invention to form a PCD element integrally bonded to the hard-metal body. A person skilled in the art of sintering diamond using ultra-high pressure and temperature (HpHT) would readily appreciate how this may be done, using an ultra-high pressure apparatus known in the art. The hard-metal substrate comprises a surface region and a core region the cobalt fraction within the surface region being greater than that within the core region prior to the HpHT sintering step. During the sintering step, when the cobalt within the substrate is molten, some of the cobalt from a surface region proximate the layer of diamond grains infiltrates into the layer of diamond grains and functions as a sintering aid, promoting the inter-growth of the diamond grains to form a coherently bonded mass of diamond, integrally bonded to the substrate.

While wanting not to be bound to a particular hypothesis, it is believed that the method exploits a known phenomenon called “cobalt drift”, in which liquid cobalt within a hard-metal being sintered tends to migrate in the same direction in which carbon moves. The movement of cobalt than therefore be controlled by setting up a carbon gradient and allowing the carbon to diffuse from a region of high concentration to one of low concentration. This movement of cobalt can be promoted by another well-known possible mechanism that is associated with the fact that low carbon content tends to result in finer WC grain size, which results in higher capillary forces in the region of low carbon and the consequent migration of liquid cobalt into that region.

### EXAMPLES

Embodiments of the invention are described in more detail with reference to the examples below, which are not intended to limit the invention.

### Example 1

Tungsten carbide powder, wherein the WC grains had an mean grain size of about 30 to 50 μm and carbon content of 6.13 weight % (MAS3000-5000, H. C. Starck), was milled in a ball mill in alcohol at the ball-to-powder ratio of 6:1 for 120 hrs. After subsequent drying the milled WC powder was blended in a Turbular dry mixer with 10 weight % cobalt powder, wherein the Co grains had an mean grain size of about 1 μm, and 0.1 weight % carbon black.

After drying the blend, cylindrical green bodies were pressed and heat-treated in vacuum at 1,000 degrees centigrade for one hour.

The porous green bodies were then heat-treated at 700 degrees centigrade for one hour in an atmosphere of hydrogen in order partially to decarburise the surface region.

The carburised green bodies were then sintered at 1420 degrees centigrade for 75 min, including a 45 minute vacuum sintering stage and a 30 minute high isostatic pressure (HIP) sintering stage carried out in an argon atmosphere at a pressure of 50 bars.

The sintered hard-metal bodies had a diameter of 26 mm and height of 30 mm. Radial cross-sectional surfaces were prepared by cutting 4 mm thick discs from the bodies by means of by EDM and then polishing the cross-sectional surfaces according to the standard metallurgical procedure.

The microstructure of the polished cross-sections was examined by optical microscopy. The disk was devoid of observable free carbon or eta-phase. The mean WC grain size in the surface and core regions was analysed using the mean linear intercept method.

In order to measure the cobalt contents within the surface and core regions, two rings with thickness of 3 mm were cut from the disk. The outer-most ring corresponded to the surface region and the inner ring to an outer portion of the core region. The remaining disc with a diameter of 14 mm corresponded to the inner bulk of the core region. The rings and disc were examined by various methods, including chemical leaching of Co. The values of the specific magnetic saturation SMS (the percentage of magnetic saturation in comparison with that of nominally pure Co) were also calculated. The results are presented in Table 1. The microstructures of the surface and core regions are shown in FIGS. 2(a) and (b), respectively. Since the concentration of carbon within the cobalt binder is positively related to the specific magnetic saturation (SMS), as is well known in the art, the latter gives an indication of the relative carbon concentrations in the binder within the regions. In this example the carbon content increases with depth from the surface, indicated by the fact that the specific magnetic saturation increases with depth from the surface. No eta-phase was detectable within any portion of the hard-metal.

TABLE 1

| | | Outer portion of | Inner portion of |
|---|---|---|---|
| | Surface region | core region | core region |
| Depth from | 0-3 | 3-6 | >6 |
| surface, mm | | | |
| Magnetic moment, | 1.52 | 1.35 | 1.33 |
| s, μTm³/kg | | | |
| Magnetic | 19.1 | 16.96 | 16.70 |
| saturation, 4p s, | | | |
| μTm³/kg | | | |
| Specific magnetic | 80.4 | 83.9 | 93.0 |
| saturation, SMS, % | | | |
| Cobalt fraction | 11.8 | 10.0 | 8.9 |
| (binder fraction), | | | |
| weight % | | | |
| Magnetic | 130 | 112 | 106 |
| coercivity, Hc, Oe | | | |
| Vickers hardness, | 1,220 | 1,240 | 1,250 |
| HV₁₀ | | | |
| Mean equivalent | 2.2 | 2.5 | 2.9 |
| diameter of carbide | | | |
| grains, D_{wc}, μm | | | |

### Example 2

A cylindrical body was made as in example 1 and used as a substrate for sintering and supporting a PCD layer integrally bonded to one of its flat ends, which will be called the working end. Apart from the use of graded substrate, other aspects of the PCD element manufacture were as would conventionally be employed.

After the PCD sintering step, the PCD element was analysed. The bond between the PCD layer and the substrate was excellent. Some of the cobalt from the surface region of the body had infiltrated into the PCD layer, as required, slightly reducing the cobalt content within a layer of the surface region proximate the interface between the substrate and the PCD layer. The cobalt content within the core of the substrate was measured to be about 8.9 weight %, which is low compared to conventional PCD substrates, as desired.

1. A superhard element comprising a polycrystalline superhard structure joined at an interface to a hard-metal body comprising metal carbide grains and a metal binder; the polycrystalline superhard structure comprising a superhard material; the hard-metal body comprising a surface region proximate the interface and a core region remote from the interface, the surface and the core regions being contiguous, the mean binder fraction in the core region being less than that in the surface region.

2. A superhard element as claimed in claim 1, the metal binder comprising a sintering aid for the superhard material.

3. A superhard element as claimed in claim 1, in which the polycrystalline superhard material is polycrystalline diamond and the metal binder comprises a solvent/catalyst material for diamond.

4. A superhard element as claimed in claim 1, in which the surface region and the core region are substantially devoid of eta-phase.

5. A superhard element as claimed in claim 1, in which the surface region is substantially devoid of chromium or vanadium or their carbides, or any combination of these.

6. A superhard element as claimed in claim 1, in which the metal binder is based on cobalt or cobalt and nickel, the mean magnetic moment, σ, in units of micro-Tesla times cubic metre per kilogram, of the hard-metal is in the range from 0.131Y to 0.161Y within the core region, and in the range from 0.110X to 0.147X within the surface region, where X and Y are the cobalt fractions, in weight %, within the surface and core regions, respectively.

7. A superhard element as claimed in claim 1, in which the mean hardness of the hard-metal within the core region is at least 2% greater than the mean hardness of the hard-metal within the surface region.

8. A superhard element as claimed in claim 1, in which the surface region has thickness of at least 0.2 mm.

9. A superhard element as claimed in claim 1, in which the mean metal binder fraction within the core region is lower than that within the surface region by a factor being in the range from 0.05 to 0.90.

10. A superhard element as claimed in claim 1, comprising a polycrystalline diamond compact.

11. A tool comprising a superhard element as claimed in claim 1.

12. A method for making a hard-metal body for a superhard element as claimed in claim 1, the method including providing an unsintered green body comprising grains of metal carbide dispersed within a metal binder, and an initial high carbon content within the green body; the green body comprising a surface region proximate a surface and a core region remote from the surface; heat treating the green body at a temperature less than 1,280 degrees centigrade for a period of time in a vacuum or inert atmosphere, the temperature being sufficiently low to avoid substantial melting of the metal binder and the temperature and time being sufficient to maintain open porosity within the surface region of green body; introducing a gaseous decarburising agent into the pores to form a decarburised surface region within the green body and maintaining the initial high carbon content within at least a portion of the core region; and liquid-phase sintering the green body.

13. A method for making a polycrystalline diamond (PCD) element according to claim 1 comprising a PCD structure joined to a hard-metal body, the method including providing a hard-metal body comprising tungsten carbide grains and a binder material comprising a solvent/catalyst material for diamond, such as cobalt, nickel, iron, manganese or certain alloys including any of these, the hard-metal body comprising a surface region proximate a surface and a core region remote from the surface, the surface and the core regions being contiguous, the mean weight fraction of metal binder in the core region being less than that in the surface region; contacting an aggregate mass of diamond grains with the surface of the hard-metal body to form a pre-sinter assembly; and subjecting the pre-sinter assembly to a pressure and temperature at which diamond is thermodynamically stable to sinter the diamond grains and form a PCD structure integrally bonded to the hard-metal body.

14. A method as claimed in claim 12, the method including removing at least part of the surface region of the hard-metal body.

15. A method as claimed in claim 13, the method including removing at least part of the surface region of the hard-metal body.
